(19) United States
(12) Patent Application Publication
(10) Pub. No.: US 2022/0371863 A1
(43) Pub. Date: Nov. 24, 2022

(54) UNIVERSAL JACK FOR A DOLLY

(71) Applicants: Ronald Charles Mehl, Cartersville, GA (US); Phillip Lynn Arnold, Cartersville, GA (US)

(72) Inventors: Ronald Charles Mehl, Cartersville, GA (US); Phillip Lynn Arnold, Cartersville, GA (US)

(21) Appl. No.: 17/664,286

(22) Filed: May 20, 2022

Related U.S. Application Data
(60) Provisional application No. 63/191,754, filed on May 21, 2021.

(51) Int. Cl. B66F 3/00; B62B 1/10

(52) U.S. Cl. CPC B66F 3/00; B62B 1/10; B62B 2203/10

(57) ABSTRACT

A universal use jack for a dolly is disclosed herein. The present invention not only allows one person to lift a trailer tongue but also allows the trailer to be maneuvered slightly right, left, forward or back so the trailer tongue can be positioned over the ball without having to reposition the vehicle. This, and other uses, are detailed in the present disclosure.

### CROSS-REFERENCE TO RELATED APPLICATION

This application claims the benefit of priority of U.S. provisional application number 63191754, filed May 21, 2021, the contents of which are herein incorporated by reference.

### BACKGROUND OF THE INVENTION

The present invention relates to jacks and, more particularly, to a jack that can be used in conjunction with a dolly.

Lifting a heavy utility trailer tongue, weighing as much as 250 pounds (lbs), to put it on the ball hitch of a vehicle is difficult for one person to accomplish without some type of assistance. If the tongue is lifted by hand, it can cause bodily injuries to the person(s) doing the lifting. Heavy trailer tongues often require two people to lift the tongue on the vehicle ball or it requires a standard jack to lift the tongue. A loaded trailer tongue can weigh as much as 500 lbs and would require some type of standard mechanical jack.

However, standard jacks have many downsides. Using a standard jack limits the maneuverability of the trailer tongue, should it not be perfectly lined up with the ball hitch on the tow vehicle. This requires the vehicle to be repositioned, sometimes several times in order to do so. A standard mechanical jack also takes considerable time and effort to use.

As can be seen, there is a need for an improved jack that ameliorates these problems. The present invention not only allows one person to lift the trailer tongue, but it also allows the trailer to be maneuvered slightly so the trailer tongue can be positioned over the ball hitch without having to reposition the vehicle. This and other uses will be readily apparent to those with skill in the art from the following disclosure.

### SUMMARY OF THE INVENTION

In one aspect of the present invention, a jack configured for use with a dolly is provided, with the jack comprising: an attachment base configured to removably couple to the dolly; a plurality of bearing supports coupled to and extending from the attachment base; a balance block extending between and pivotally coupled to the plurality of bearing supports, with the balance block defining a receiver hole; and a lift tool removably inserted into the receiver hole, the lift tool being configured to engage a surface of an apparatus to be lifted.

In another aspect of the present invention, an assembly is provided that comprises: a dolly; a jack comprising: an attachment base removably coupled to the dolly; a plurality of bearing supports coupled to and extending from the attachment base; a balance block extending between and pivotally coupled to the plurality of bearing supports, with the balance block defining a receiver hole; and a lift tool removably inserted into the receiver hole, the lift tool being configured to engage a surface of an apparatus to be lifted.

As used herein, the term “dolly” should be understood by its plain and ordinary meaning. Specifically, a “dolly” refers to a wheeled handcart for moving heavy loads.

As stated above, lifting a utility trailer tongue in order to put it on the ball hitch of a vehicle is difficult for one person to accomplish without some type of assistance. The present invention claimed here solves this problem. Typically, trailer tongues are lifted by hand, and it usually takes two people to accomplish that task. Hand lifting a trailer tongue, even by two people, puts stress on an individual's back and in many cases causes back issues which may result in a lawsuit. The use of a standard jack prevents the trailer tongue from being maneuvered over the ball on the vehicle and requires the vehicle driver to reposition the vehicle so that it lines up with the ball, which often takes several tries. The novel jack detailed herein allows manipulation of the trailer tongue effortlessly in one motion, by one person. The tongue can also be positioned over the ball hitch by the simple movement of the dolly (e.g., right, left, forward, or back) by the operator, meaning that a vehicle doesn't need to be repositioned in order to adjust a relative position of the ball and hitch.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a side elevation view of an embodiment of the present invention, prior to use;

FIG. 2 is a side elevation view of the embodiment of the present invention, in use to lift and move;

FIG. 3 is a side elevation view of the embodiment of the present invention, in a holding up mode;

FIG. 4 is a perspective view of a first configuration of the embodiment of the present invention;

FIG. 5 is a cross-sectional view of the first configuration of the embodiment of the present invention, taken on line 5-5 of FIG. 4;

FIG. 6 is an enlarged cross-sectional detail view of the first configuration of the embodiment of the present invention, oriented in the position of FIG. 1;

FIG. 7 is an enlarged cross-sectional detail view of the first configuration of the embodiment of the present invention, oriented in the position of FIG. 3;

FIG. 8 is an exploded cross-sectional detail view of the interchangeable tool configurations of the embodiment of the present invention;

FIG. 9 is a perspective view of a second configuration of the embodiment of the present invention;

FIG. 10 is an enlarged cross-sectional detail view of the second configuration of the embodiment of the present invention, oriented in the position of FIG. 1;

FIG. 11 is a perspective view of a third configuration of the embodiment of the present invention;

FIG. 12A is an enlarged cross-sectional detail view of the third configuration of the embodiment of the present invention, oriented in the position of FIG. 1; and

FIG. 12B is an enlarged cross-sectional detail view of the third configuration of the embodiment of the present invention, oriented in the position of FIG. 3.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, one embodiment of the present invention is a jack and dolly combination the offers many benefits over the prior art.

The present invention can lift the tongue of a heavy trailer (e.g., as much as 300 pounds), whether loaded or unloaded, effortlessly by one person. When the jack is totally engaged, in the raised position, the tongue can be moved side to the side, forward, or back to position the tongue over the ball hitch of the vehicle by simple movements of the dolly, to which the present invention is attached, by the operator without having to reposition the vehicle.

The present invention can be attached to any type of moving dolly or hand truck and, when it is used to lift a trailer tongue, the jack can remain in the raised position without support needed from the operator such that they are free to back up the vehicle, making it possible for a single person to hook up a trailer without requiring the assistance of any kind. The present invention allows the tongue to be maneuvered or aligned with the ball hitch without having to move the vehicle.

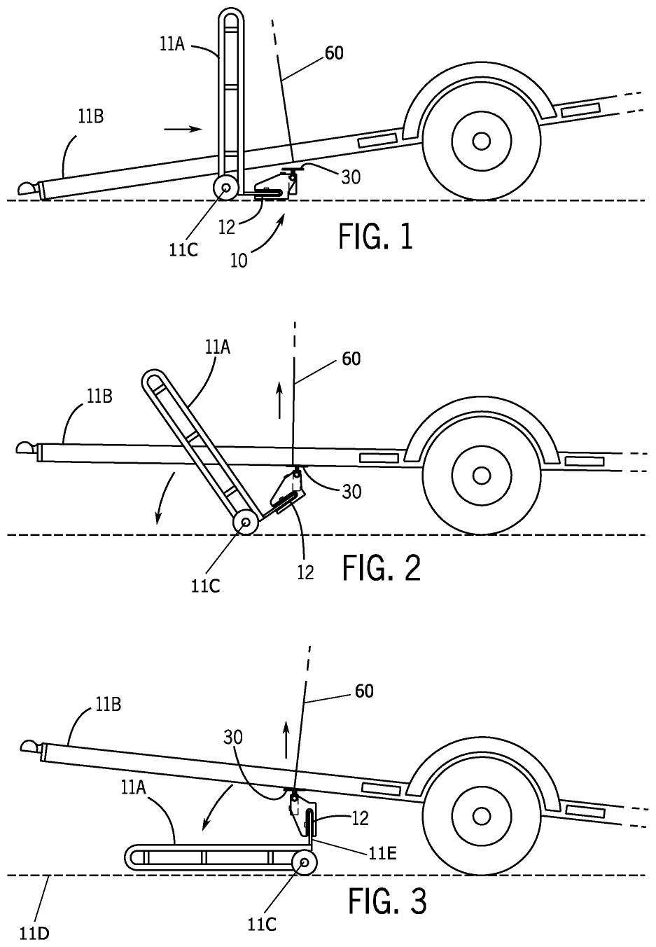

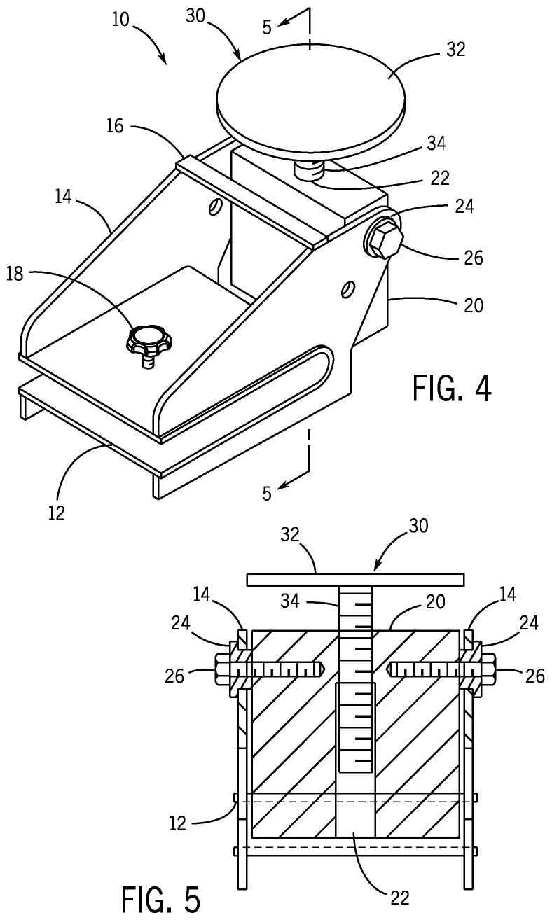

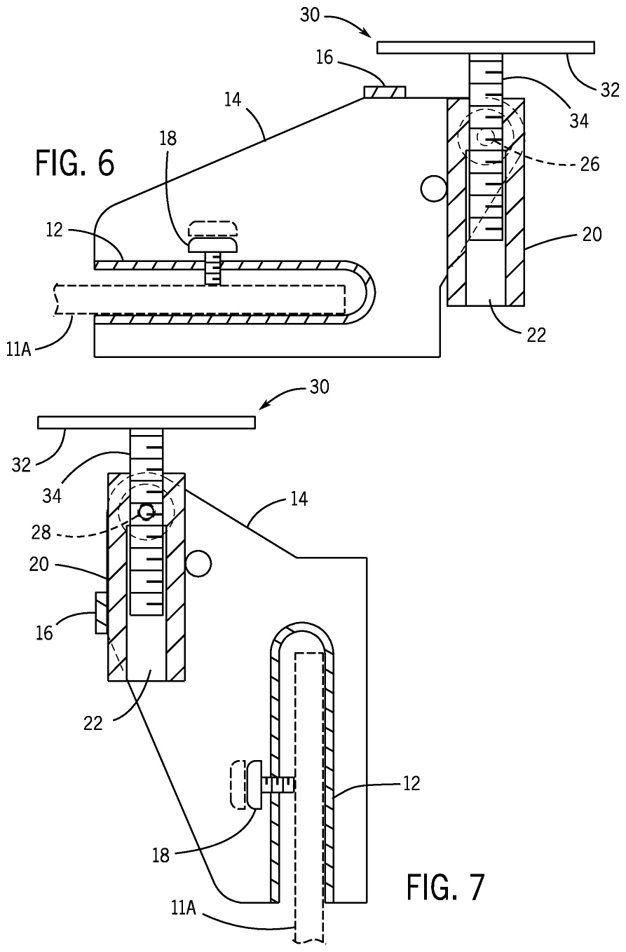

Referring now to FIGS. 1-12B, a dolly jack 10 is shown. The jack 10 is provided with a clamshell attachment base 12 that secures the entire jack 10 to a dolly 11A, in use. The dolly 11A and jack 10 combination may be used to lift a trailer 11b (described in greater detail below). The attachment base 12 is substantially U-shaped defines a slot that a toe plate 11E (the portion used to primarily lift the load) of the dolly 11A is slid into. The attachment base 12 is also provided with a locking mechanism 18 (e.g., a lockdown knob, as shown in FIG. 4) for clamping the base 12 to the toe plate of the dolly 11A. FIGS. 6 and 7 demonstrate this clamping/locking action.

Extending from the base 12 are a pair of bearing supports 14. The bearing supports 14 support a balance block 20. The balance block 20 is rotatable relative to the bearing supports 20 via one or more shafts 26 (which may, in certain embodiments, be removable to uncouple the balance block 20 from the bearing supports 20). The shaft(s) 26 are carried on two bearings 24. As shown in FIGS. 1-3, 6 and 7, the balance block 20 on the shafts 26 rotates as the dolly 11A is pivoted downwardly and upwardly (explained in greater detail below), ensuring that an adjustable lift tool 30 remains facing directly upwardly. The bottom portion of the balance block 20 functions as a counterweight to keep the entire component level as the jack 10 is raised and lowered. A rotation stop 16 is provided to keep the balance block 20 from over-rotating when the jack 10 reaches its full height (e.g., see FIG. 7). Thus, the rotation stop 16 is designed to prevent the balance block 20 from rotating beyond a predetermined amount (e.g., about 90 degrees relative to a horizontally disposed jack position, as shown from FIGS. 6 to 7) in a first direction of rotation.

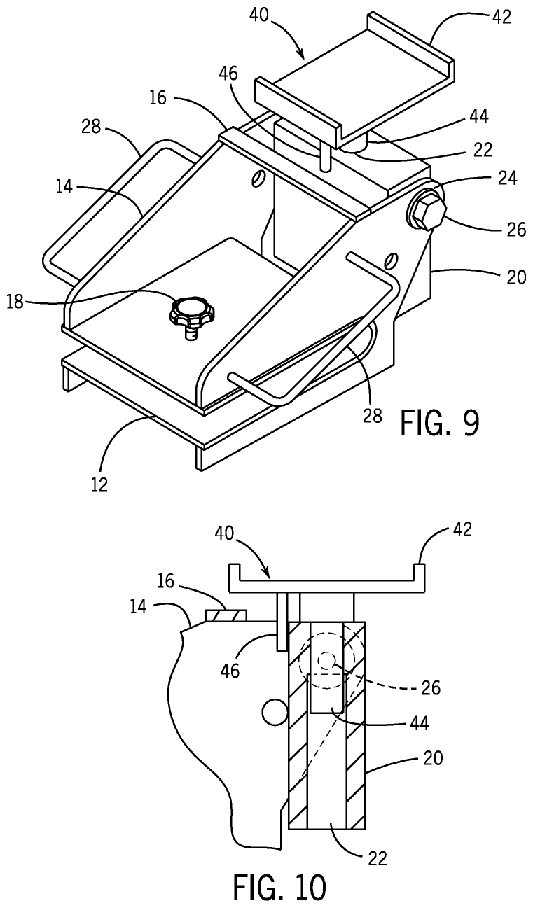

In certain embodiments, as shown in FIG. 9, the jack 10 may include handles 28 extending away from the brackets 14. The handles 28 are a safety feature to keep the operator from carrying the jack 10 by the rotation stop 16, where there is a danger of pinching one's fingers. The handles 28 also make it easier to attach the jack 10 to the toe plate 11E. For example, the dolly 11A can be laid on the ground, the handles 28 can be grasped and the attachment base 12 slid onto a center portion of the toe plate 11E.

As shown in FIGS. 4 and 5, a receiver hole 22 is defined in the balance block 20 to receive various lift tools 30, 40, 50. As depicted in FIGS. 4-8, a first lift tool 30 includes a round lifting platform 32 and a threaded rod 34 (e.g., a trapezoidal thread form) extending away from the lifting platform 32. As shown in FIG. 5, the threaded rod 34 may thread into the balance block 20 such that the lifting platform's height can be slightly adjusted, as needed. The rod 34 is removable from the balance block 20, allowing different lift tools 40, 50 to be used, adding to the versatility of the jack 10.

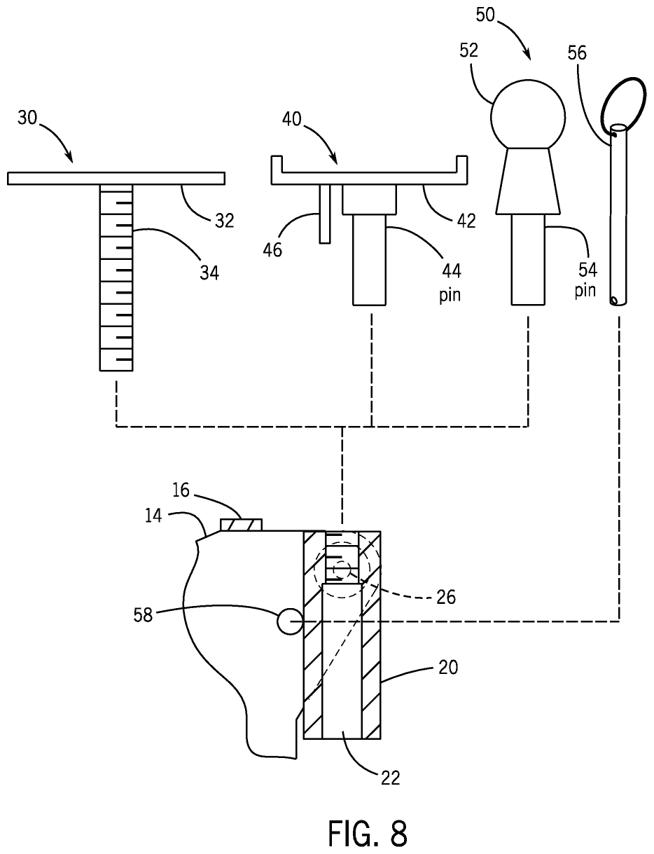

More specifically, FIGS. 8-12B depict alternative configurations of the presently described embodiment that employ other lift tools 40, 50. FIG. 8 demonstrates the interchangeable nature of the various lift tools 30, 40, 50 and various designs the lift tools can take.

As shown in FIGS. 8-10, a fixed lift tool 40 is provided that has a square or rectangular platform 42 with a downwardly depending drop-in rod 44. A rotational stop 46 is spaced from the drop-in rod 44 and extends downwardly, as well. This stop 46 is configured to engage an outer wall of the balance block 20 to prevent the lift tool 40 from rotating relative to the balance block 20, increasing the stability thereof when lifting the trailer 11B.

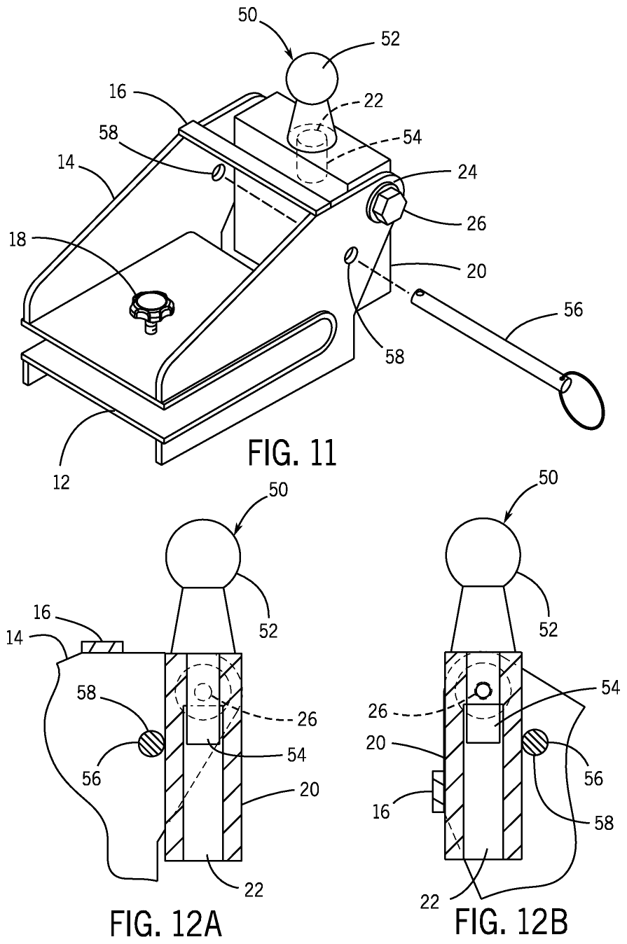

As exemplified in FIGS. 11-12B, a tow ball lift tool 50 may also be selectively used. This tool 50 includes a ball 52 and a downwardly depending drop-in rod 54. The tow ball lift tool 50 can be used to tow a trailer 11B by hand (rather than using a vehicle). In this configuration (as well as the other configurations), the balance block 20 can be locked in two positions: (1) perpendicular relative to the slot in the attachment base 12, as shown in FIGS. 11 and 12A, and (2) parallel to the attachment base slot, as shown in FIG. 12B. To do this, receiver holes 58 are defined in the bearing supports 14, through which a block locking pin 56 can extend. In the configuration shown in FIG. 12A, the block 20 is prevented from clockwise rotation and, in FIG. 12B, the block 20 is prevented from rotation in both directions.

In use, the jack 10 functions as a jack attachment to any type of moving dolly 11A or hand truck. With the jack 10 attached to a dolly 11A, and as shown in FIG. 1 in an upright position, it can be moved under the main body or tongue of the trailer 11B. Line 60 denotes a vector of the load of the trailer 11B perpendicular to a direction of its (typically) horizontal extent. As the dolly handle is pulled back and the dolly 11A tilts (see FIG. 2), the jack 10 rises up to push upwardly on the load (thus applying a lifting force). As it rises, the lifting platform 32 is maintained substantially level by the balance block 20. Once the dolly handle is fully positioned on the ground 11D in a laying position, as shown in FIG. 3, the jack 10 is fully raised and maintained in that position due to the load being over or behind the axle 11C on the dolly 11A. See, in particular, the downward vector 60 of the load in FIG. 3, which shifts from to the right of the axle 11C in FIGS. 1 and 2 to the left of the axle in FIG. 3 (the same principle, of course, holds true regardless of the direction the dolly 11A faces when initially positioned in the upright position). Thus, it is possible for the operator to release the handle to perform work on the load (e.g., if the jack 10 were used to raise an apparatus to do work on an underside thereof) or back up a vehicle to make a connection to the ball hitch of the trailer 11B. From the ground, the dolly 11A can be manipulated left, right, etc. to make small adjustments to the trailer's position. Alternatively, the jack 10 and dolly 11A could be maintained in a position similar to FIG. 2, which allows the operator to manipulate the trailer 11B in such a way that the ball hitch is moved slightly (e.g., to position it over the ball of a vehicle hitch and lower it thereupon).

Based on the foregoing, it is clear the primary purpose of the present invention is to permit one person to lift heavy trailer tongues to position the tongue over the ball on a tow vehicle. In trailer rental locations there is often only one person available to connect trailers 11B to a customer's vehicle. This often requires the customer's help in lifting the trailer tongue and as a result, this has led to lawsuits that could be avoided if the presently describe jack 10 was available. The present invention, as discussed, also applies to moving a small trailer for a short distance by hand (e.g., around a sales or rental lot) without having to hook it up to a vehicle (which can be achieved by using the aforementioned tow ball lift tool 50).

However, the present invention also has many uses that go beyond that specific use case. For example, when attached to a lever dolly, the jack 10 may be used to lift the axels on small vehicles or trailers in order to repair tires or work on the brakes. The present invention, attached to a lever dolly, can be used to quickly lift race cars in the pit to change tires quickly. The present invention can be used to lift, move, or reposition heavy equipment over small distances in a factory or workshop, especially in instances where a forklift cannot be used due to space constraints. Specialized lifting tools can be added depending on the type of lifting requirements of other applications. In general, these lifting tools can be configured to engage a lower surface of a wide variety of apparatuses (which include, but are not limited to, all the aforementioned devices) to be raised.

As those with skill in the art will appreciate, the jack 10 may be reconfigured in form in various ways. For example, as presently configured, the ground clearance is 5 or fewer inches. However, it could be designed to even further lower the ground clearance, making it capable of getting under items lower to the ground. Conversely, the lifting height can be increased using a dolly 11A with a longer base/toe plate or adjustments to the length of the present invention.

In an exemplary method, to make the jack 10, a base plate 12 is formed into the shape of a clamshell, allowing the jack 10 to be attached to a dolly platform. Bearing supports 14 are welded to the clamshell base 12 in such a manner as to reinforce the base 12 so that it does not deform in use (e.g., see the pieces of the supports 14 that extend along the top and bottom sides of the base 12). A balance block 20 is held to the bearing supports 14 by fasteners (e.g., bolts) that serve as a shaft 26, allowing the balance block 20 to rotate as the jack 10 is raised keeping the lifting platform level. Various specialized lift tools may be formed to serve various purposes/functions. Further, auxiliary wheels can be fixed to the dolly 11A used with the jack 10 of the present invention, making it more maneuverable, such as pneumatic tires or swivel casters.

In general, all of the components are necessary for the proper operation of the jack 10. However, the use of lighter components may be helpful in certain circumstances. The use of corrosion-resistant materials would improve the product since it is intended for use outdoors.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A jack configured for use with a dolly, the jack comprising:
an attachment base configured to removably couple to a toe plate of the dolly;
a plurality of bearing supports coupled to and extending from the attachment base;
a balance block extending between and pivotally coupled to the plurality of bearing supports; and
a lift tool engaged with the balance block, the lift tool being configured to engage a surface of an apparatus to be lifted.

2. The jack of claim 1, further comprising a locking mechanism configured to clamp the attachment base to a toe plate of the dolly.

3. The jack of claim 1, further comprising a rotation stop configured to prevent the balance block from rotating beyond a predetermined amount in a first direction of rotation.

4. The jack of claim 1, wherein the lift tool comprises a platform and a threaded rod, with the threaded rod being threadably inserted into a receiver hole defined in the balance block, and with the platform being configured to directly engage the surface of the apparatus to be lifted.

5. The jack of claim 1, wherein the lift tool comprises a platform, a rod, a rotational stop, with the rod being removably inserted into a receiver hole defined in the balance block, with the platform being configured to directly engage the surface of the apparatus to be lifted, and with the rotational stop being configured to engage an outer surface of the balance block to prevent the lift tool from rotating relative to the balance block.

6. The jack of claim 1, wherein the lift tool comprises a ball and a rod, with the rod being removably inserted into a receiver hole defined in the balance block, and with the ball being configured to engage a ball hitch of a trailer.

7. An assembly comprising:
a dolly comprising a toe plate;
a jack comprising:
an attachment base removably coupled to the toe plate of the dolly;
a plurality of bearing supports coupled to and extending from the attachment base;
a balance block extending between and pivotally coupled to the plurality of bearing supports; and
a lift tool engaged with the balance block, the lift tool being configured to engage a surface of an apparatus to be lifted.

8. The assembly of claim 7, wherein the balance block rotates relative to the attachment base as the dolly is rotated between an upright position and a laying position such that the balance block remains directed vertically in both the upright position and the laying position.

9. The assembly of claim 7, wherein the dolly is rotatable between an upright position and a laying position, and wherein the jack is lifted upwardly when the dolly is rotated from the upright position to the laying position.

10. The assembly of claim 7, wherein the dolly is rotatable between an upright position and a laying position, and wherein, in use:
in the upright position, the jack does not engage the surface of the apparatus; and
in the laying position, the jack engages the surface of the apparatus and applies a lifting force thereto.
